(19) United States
(12) Patent Application Publication
(10) Pub. No.: US 2010/0059602 A1
(43) Pub. Date: Mar. 11, 2010

(54) SUBSTANCE DISPENSER

(75) Inventors: Joe Chiou, Wilmette, IL (US); Sean Bellinger, Kenosha, WI (US)

Correspondence Address: MOORE & VAN ALLEN PLLC, P.O. BOX 13706, Research Triangle Park, NC, 27709, US

(73) Assignee: Technical Concepts, LLC, Mundelein, IL (US)

(21) Appl. No.: 12/555,348

(22) Filed: Sep. 8, 2009

Related U.S. Application Data
(60) Provisional application No. 61/095,440, filed on Sep. 9, 2008.

(51) Int. Cl. A01G 27/00; A01G 25/09; G04C 23/42

(52) U.S. Cl. 239/70; 222/649; 222/645; 239/1

(57) ABSTRACT

A cartridge stores gas under pressure and a container stores a fragrance substance in the housing. A valve controls the release of the gas. An atomizer receives the gas and draws the fragrance substance from the container such that the fragrance substance is sprayed into the atmosphere. A controller opens the valve at predetermined intervals.

This application claims benefit of priority under 35 U.S.C. §119(e) to the filing date of to U.S. Provisional Application No. 61/095,440, as filed on Sep. 9, 2008, which is incorporated herein by reference in its entirety.

### FIELD OF THE INVENTION

The invention relates to dispensing systems and more particularly to a dispensing system that can dispense substances such as fragrances. Such dispensing systems may be used in public facilities and may be operated automatically. One type of dispenser sprays a substance such as a fragrance from a container using propellants and volatile organic compounds (VOC's). The use of such propellants and VOC's are not considered to be environmentally friendly.

### SUMMARY OF THE INVENTION

In one embodiment a gas such as CO₂ is used as the propelling agent to propel the substance into the air. CO₂ is an environmentally friendly gas and is not flammable. One embodiment of the dispensing system comprises a housing adapted to be mounted to a wall or other surface. The housing holds a cartridge that stores the gas under pressure and a container that stores a fragrance substance. A valve controls the release of the gas from the cartridge. An atomizer receives the gas and draws the fragrance substance from the container such that the fragrance substance is sprayed into the atmosphere. A controller controls the actuation of the valve. The housing may include an aperture through which the fragrance substance is discharged where the aperture is located in a movable housing cover. The system may be battery powered. Both the cartridge and the container are replaceable. A regulator may be used for controlling the pressure of the gas.

### BRIEF DESCRIPTION OF THE DRAWINGS

FIG. 1 is a perspective view showing an embodiment of a dispenser according to the invention.

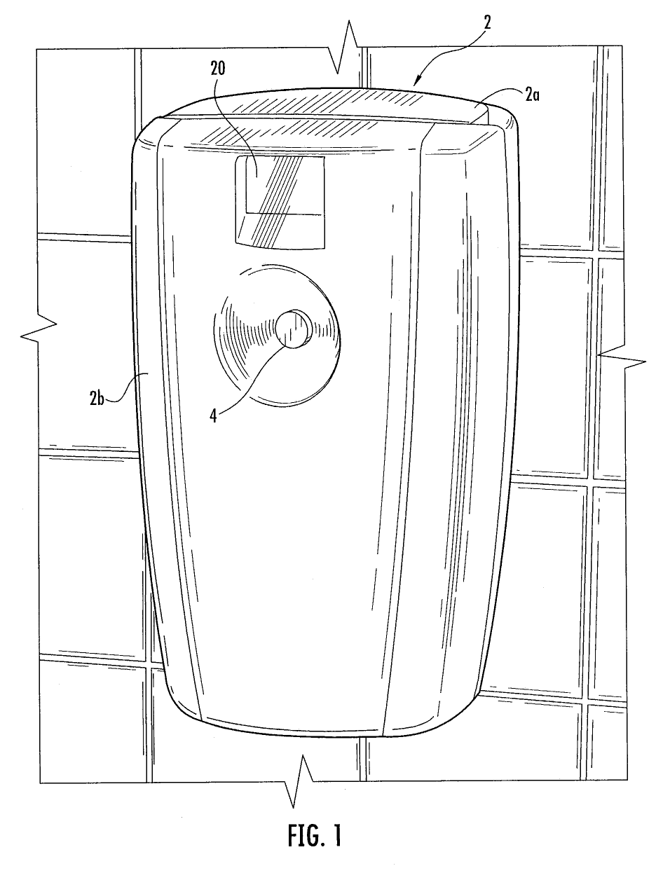

FIG. 2 is a perspective view showing the dispenser of Fig. in an open position.

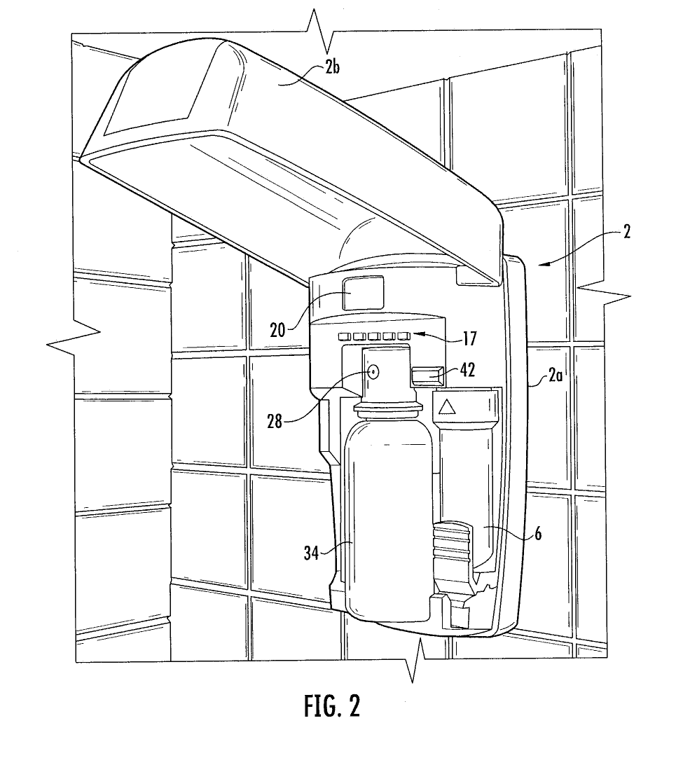

FIG. 3 is a back view showing an embodiment of the internal structure of the dispenser of FIG. 2.

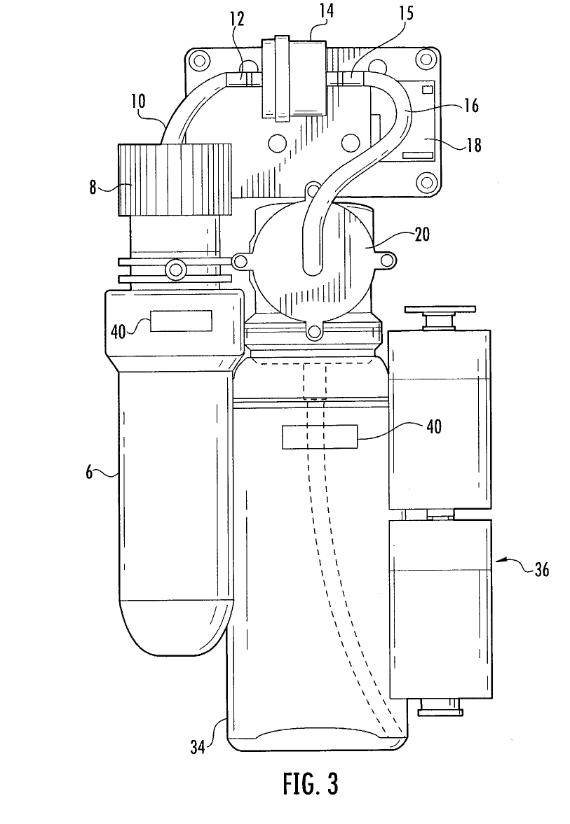

FIG. 4 is a top view showing an embodiment of the internal structure of the dispenser of FIG. 2.

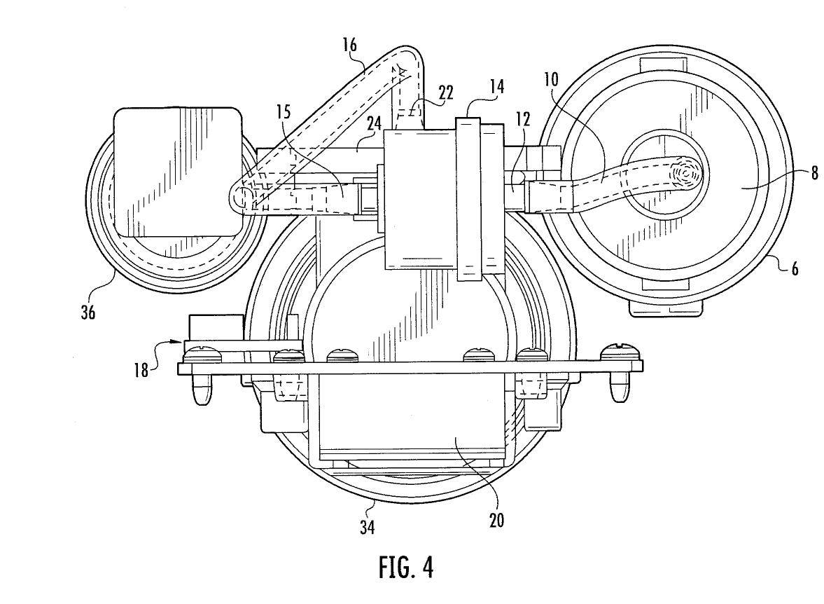

FIG. 5 is a section view showing the internal structure of the atomizer.

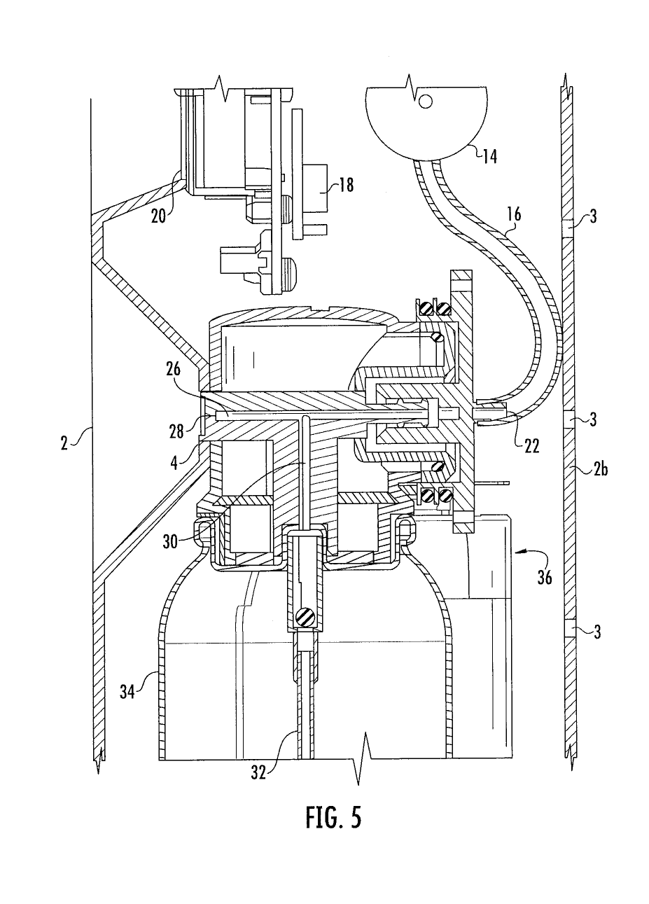

### DETAILED DESCRIPTION OF PREFERRED EMBODIMENTS OF THE INVENTION

In one embodiment the dispensing system of the invention comprises a housing 2. Housing 2 has a housing base 2a that may be secured to a wall or other surface using fasteners such as screws, not shown, that engage apertures 3 in the housing base 2a. Housing base 2a may support the various dispenser components as will hereinafter be described. A housing cover 2b is releasably secured to housing back 2 to cover the various dispenser components. A lock may be used to releasably secure the hosing cover 2b to the housing base 2a. Housing cover 2b includes an aperture 4 through which the substance is dispensed.

CO₂, or other environmentally friendly gas, is stored under pressure in a replaceable cartridge 6. Cartridge 6 is releasably connected to a pressure regulator 8 that discharges the gas into conduit 10. The pressure regulator 8 controls the pressure of the gas such that it is discharged from the pressure regulator 8 through conduit 10 at a desired pressure. The cartridge 6 may be releasably connected to the regulator 8 through a threaded connection, a quick release coupling or the like such that it is removable from housing 2.

Conduit 10 is connected to the input port 12 of a solenoid valve 14 that uses an electrically actuated solenoid to open and close a valve diaphragm to allow the flow of gas through the valve. The output port 15 of valve 14 is connected to conduit 16. In one embodiment the solenoid is actuated to open valve 6 at predetermined time intervals. To control the operation of the valve 6, a controller 18 such as a PCB controller with a LCD display 20, processor or other program logic may be used. The controller 18 controls the opening of the valve 6 in a programmed pattern such that the spray is dispensed in a desired pattern. For example the controller may control the valve to control a time interval between opening of the valve and/or the duration the valve remains open. A user interface such as buttons 17 may be provided to allow a user to change the spray pattern. The LCD display 20 may also be used to display data about the operation of the device such as the current spray pattern, the number of sprays, elapsed time, the number of sprays or time to empty or the like.

Conduit 16 connects to the input port 22 of atomizer 24 such that atomizer 24 is in fluid flow communication with the output port 15 of valve 14 and gas from valve 14 is delivered under pressure to atomizer 20. Atomizer 20 includes a first passageway 26 that is connected at one end to conduit 16 via port 22 for receiving the gas under pressure from valve 14. The opposite end of passageway 22 is connected to a nozzle 28 that is positioned behind opening 4 in housing 2. A substance supply passageway 30 connects with passageway 26 such that the passageways are in fluid communication with one another. Passageway 30 is connected to a tube 32 that extends to the bottom of a container 34 filled with a fragrance substance. Container 28 is releasably connected to atomizer 24 such that the fragrance substance can be resupplied either by removing and refilling the container or by removing the empty container and replacing it with a full container. Container 34 is connected to atomizer 24 through a releasable connector 30 such as a threaded connection, quick connect coupling or the like.

Upon the opening of valve 6, a predetermined quantity of the gas under pressure is transmitted through conduit 16 to atomizer 24 where the gas is accelerated through passageway 26. The fast flowing gas in passageway 26 draws the fragrance substance from container 34 through tube 32 and passageway 30 and into passageway 26. The gas and fragrance substance are propelled from atomizer 24 via nozzle 28 such that the fragrance substance is sprayed as air born droplets in a desired droplet size through aperture 4 and into the atmosphere.

The system may be powered by a portable, removable or rechargeable battery pack 36. In the illustrated embodiment a series of standard batteries are use although other self-contained power sources may be used. A solar panel may also be used either as the main power source or as an assisting power source to extend battery life. Alternatively, the battery pack 32 may be replaced by a permanent source of electricity such as a plug to a wall socket or hard wiring to an electric grid.

An RFID tag 40 or other machine readable tag may be provided on the refills of cartridge 6 and/or container 34 that can be read by a RFID transmitter/receiver 42 or other sensor mounted on the housing 1. A signal from RFID transmitter/receiver 42 is transmitted to the controller 18 to control operation of the dispenser. The tags 40 may be used for inventory control. For example the controller may track the life cycle of the containers, the number or type of containers used or the like. The tag 40 may also be used for security purposes to ensure that only compatible refills are used in the system. The tag may contain a code such as a serial number that is transmitted by RFID transmitter/receiver 42 to the controller 18. The code can be read by the controller 18 to authenticate the replaced container 34 or cartridge 6. The system may be deactivated if a non-compatible refill is installed, i.e. if the code is not recognized by the controller. Operation of the dispenser may only be enabled if the code is authenticated.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A dispensing system comprising:
a housing adapted to be mounted to a surface;
a cartridge storing gas under pressure in the housing;
a container storing a fragrance substance in the housing;
a valve for controlling the release of the gas;
an atomizer for receiving the gas and drawing the fragrance substance from the container such that the fragrance substance is sprayed into the atmosphere;
a controller for opening the valve at predetermined intervals.

2. The dispensing system of claim 1 wherein the gas is CO₂.

3. The dispensing system of claim 1 wherein the valve is a solenoid valve.

4. The dispensing system of claim 1 wherein the controller controls the time interval of actuation of the valve.

5. The dispensing system of claim 1 wherein the housing includes an aperture through which the fragrance substance is discharged.

6. The dispensing system of claim 5 wherein the aperture is located in a housing cover.

7. The dispensing system of claim 5 wherein said cover is movable relative to a housing base.

8. The dispensing system of claim 1 wherein a battery supplies power to the valve and the controller.

9. The dispensing system of claim 1 wherein the cartridge is removable.

10. The dispensing system of claim 1 wherein the container is removable.

11. The dispensing system of claim 1 further including a regulator for controlling the pressure of the gas.

12. The dispensing system of claim 1 wherein said controller is a PCB controller.

13. The dispensing system of claim 1 wherein said controller is a processor.

14. The dispensing system of claim 1 wherein said controller actuates the valve such that the fragrance substance is dispensed in a desired pattern.

15. The dispensing system of claim 14 wherein the controller controls the valve to control a time interval between a first opening of the valve and a second opening of the valve.

16. The dispensing system of claim 14 wherein the controller controls a duration valve is open.

17. The dispensing system of claim 1 further including a user interface operatively connected to the controller to program the controller.

18. The dispensing system of claim 1 further including a tag on the container that can be read by a sensor.

19. The dispensing system of claim 1 further including a tag on the cartridge that can be read by a sensor.

20. A method of delivering a fragrance substance comprising:
providing a cartridge storing gas under pressure and a container storing a fragrance substance, an atomizer for receiving the gas from the cartridge and for drawing the fragrance substance from the container such that the fragrance substance;
controlling the release of the gas from the cartridge using a valve;
automatically opening the valve at predetermined intervals to control the release of gas.
